(19) United States
(12) Patent Application Publication
(10) Pub. No.: US 2005/0024348 A1
(43) Pub. Date: Feb. 3, 2005

(54) Driving circuit for solving color dispersion

(75) Inventors: Chang-Ho Liou, Changhua County (TW); Jun-Ren Shih, Changhua County (TW); Jan-Ruei Lin, Jhonghe City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/695,813

(22) Filed: Oct. 30, 2003

(30) Foreign Application Priority Data
Jul. 30, 2003 (TW) 92120875

(51) Int. Cl. G09G 5/00

(52) U.S. Cl. 345/204

(57) ABSTRACT

A driving circuit for solving color dispersion is disclosed, which includes a coding unit, a reference voltage generator and at least one data driver. The coding unit generates a plurality of coded data based on three Gamma curves. The reference voltage generator receives the coded data and converts the coded data into a plurality of reference voltages, such that the data driver drives display cells on the display array in accordance with the reference voltages.

### BACKGROUND OF THE INVENTION

1. Field of the Invention

The present invention relates to a display driving circuit and, more particularly, to a driving circuit for solving color dispersion and a reference voltage generator thereof.

2. Description of Related Art

Because CRTs have huge volumes and generate radiation, they are increasingly replaced by flat panel displays. A liquid crystal planar display, which drives display cells of the display panel using voltage-driving, is mostly popular in current market. Each pixel on the display panel is controlled by three primary colors R (red), G (green) and B (blue). The three primary colors have different optical features and thus require different curves for operating voltages and brightness. FIG. 1a shows a graph of operating voltage to resolution curves respectively to the three primary colors, and FIG. 1b shows a graph of brightness to resolution curves, which are Gamma curves respectively for the three primary colors with different operating voltages.

However, upon design consideration, flat panel displays in current market apply a same operating voltage to R, G, B colors; i.e., data drivers (source drivers) are provided with a same Gamma curve (as shown in FIG. Ic) to drive R, G, B sub-pixels, so that brightness of pixels on display panel presents error with respect to original brightness and thus the displays present color dispersion. For current techniques, an operating voltage is provided by voltage regulator and variable resistor. In case of provision of three different operating voltages, consumption of voltage regulator and variable resistor must be increased by three times, thus requiring large space and increasing power dissipation.

Therefore, it is desirable to provide an improved driving circuit capable of concurrently offering Gamma curves for R, G, B colors, to mitigate and/or obviate the aforementioned problems.

### SUMMARY OF THE INVENTION

An object of the present invention is to provide a driving circuit for solving color dispersion and a reference voltage generator thereof, which can effectively avoid color dispersion to increase display quality.

Another object of the present invention is to provide a driving circuit for solving color dispersion and a reference voltage generator thereof, which can provide three separate and regulable Gamma reference voltages.

To achieve the objects, the driving circuit for solving color dispersion is implemented in a flat panel display with a plurality of display cells. The driving circuit includes a coding unit, a reference voltage generator and a driving unit. The coding unit generates a plurality of coded data according to a plurality of characteristic curves. The reference voltage generator receives the coded data and converts the coded data into a plurality of reference voltages. The driving unit receives the reference voltages and accordingly drives the display cells.

Other objects, advantages, and novel features of the invention will become more apparent from the following detailed description when taken in conjunction with the accompanying drawings.

### BRIEF DESCRIPTION OF THE DRAWINGS

FIG. 1a is a schematic graph of typical operating voltage to resolution curves respectively to R, G, B colors;

FIG. 1b is a schematic graph of typical brightness to resolution curves respectively to different R, G, B operating voltages;

FIG. 1c is a schematic graph of a typical Gamma curve;

FIG. 2 is a schematic diagram of functional blocks in accordance with a preferred embodiment of the invention;

FIG. 3 is a schematic diagram of functional blocks inside the reference voltage generator of FIG. 2; and

FIG. 4 is an embodied timing diagram in accordance with the invention.

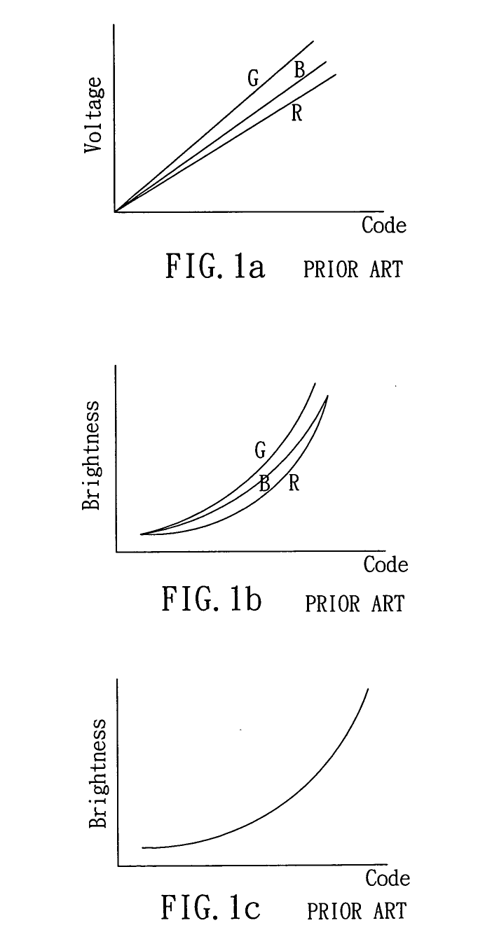

### DETAILED DESCRIPTION OF THE PREFERRED EMBODIMENT

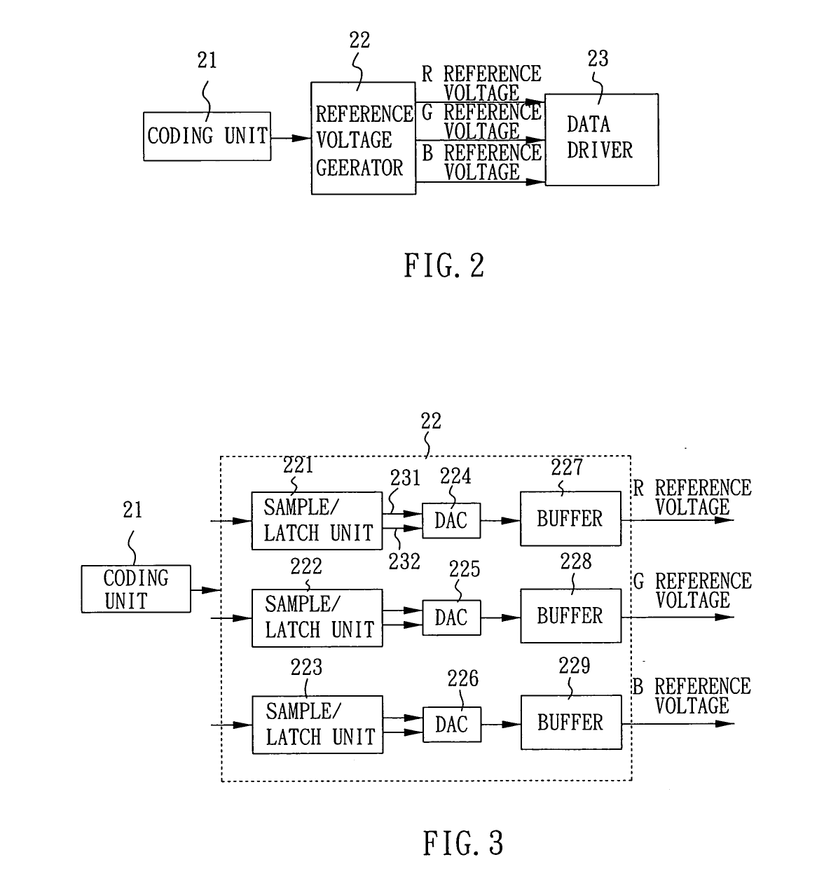

With reference to functional blocks of FIG. 2, there is shown a preferred embodiment of a driving circuit for solving color dispersion. In FIG. 2, the driving circuit essentially includes a coding unit 21, a reference voltage generator 22 and a data driver 23. The coding unit 21 generates a plurality of coded data according to Gamma curves of three primary colors. Positive and negative polarities of the Gamma curves are respectively divided into a plurality of selection voltages. In this embodiment, the number of selection voltages is 128, each having a range of about 39 mV, which is coded by 7 bits, thus using a coded data derived from the 7 bits can select a desired voltage.

The reference voltage generator 22 receives the coded data and applies the same to digital-to-analog conversion in order to generate a plurality of RGB Gamma reference voltages. FIG. 3 shows functional blocks inside the reference voltage generator 22 of FIG. 2. In FIG. 3, the reference voltage generator 22 essentially includes a plurality of sample/latch units 221, 222, 223, a plurality of digital-to-analog converters 224, 225, 226 and a plurality of buffers 227, 228, 229. There are two control signal lines 231, 232 between each sample/latch unit and digital-to-analog converter.

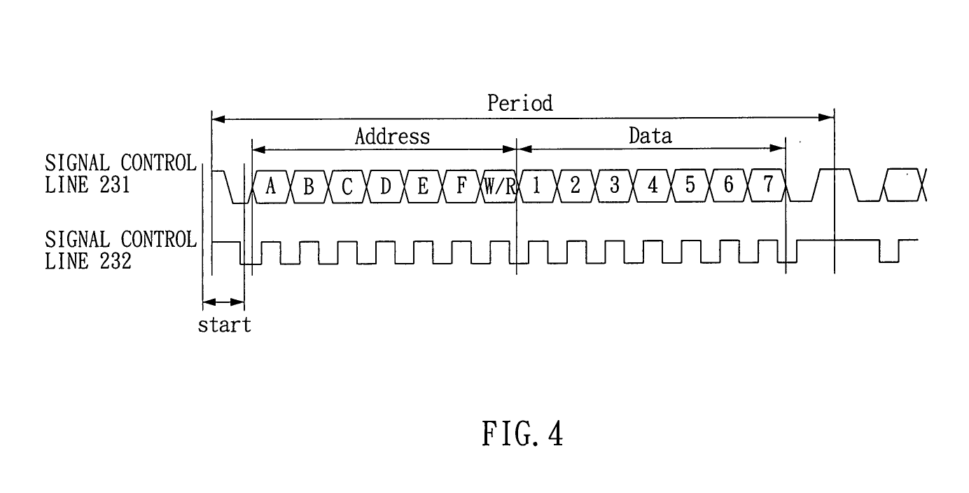

The sample/latch units 221, 222, 223 receive encoded data generated by the coding units respectively, sample/latch the encoded data and transmit the encoded data to corresponding digital-to-analog converters through corresponding control signal lines 231, 232. FIG. 4 shows a timing of data input via the control signal lines 231, 232 of FIG. 3. In FIG. 4, the control signal line 231 is regarded as an address line and the control signal line 232 is regarded as a data line to transmit data (coded value) with 7 bits.

Referring to FIGS. 2 and 3 at the same time, the digital-to-analog converters 224, 225, 226 receive the coded values and convert the same from digital to analog to thus generate a plurality of reference voltages, each corresponding to Gamma curve of a primary color. The buffers 227, 228, 229 enhance amplitudes of the reference voltages for outputting to the data driver 23. Thus, the data driver 23 can drive R, G, B subpixels (not shown in figure) on display panel based on Gamma reference voltages of three primary colors R, G, B, such that brightness of the subpixels can accurately be presented. Therefore, it is prevented that brightness of pixels on display panel presents error with respect to original brightness and further the displays present color dispersion.

In view of the foregoing, it is known that the invention can generate different encoded data based on Gamma curves derived from different primary colors and convert the encoded data into analog form from digital form, thus obtaining Gamma reference voltages of three primary colors for provision to the data driver. The data driver accordingly displays accurate brightness of pixels on display panel. Thus, color dispersion presented on display is solved and display quality is increased. In addition, three separate and regulable Gamma reference voltages are also provided.

Although the present invention has been explained in relation to its preferred embodiment, it is to be understood that many other possible modifications and variations can be made without departing from the spirit and scope of the invention as hereinafter claimed.

1. A driving circuit for solving color dispersion, implemented in a flat panel display with a plurality of display cells, the driving circuit comprising:
a coding unit, to generate a plurality of coded data according to a plurality of characteristic curves;
a reference voltage generator, to receive the coded data, convert the coded data from digital to analog, and generate a plurality of reference voltages; and
a driving unit, to receive the reference voltages and accordingly drive the display cells.

2. The driving circuit as claimed in claim 1, wherein the reference voltage generator further comprises a plurality of digital-to-analog converters for digital to analog conversion.

3. The driving circuit as claimed in claim 2, wherein the digital-to-analog converters input the coded data through sample/latch.

4. The driving circuit as claimed in claim 2, wherein each digital-to-analog converter inputs the coded data through a plurality of control signal lines.

5. The driving circuit as claimed in claim 1, wherein the reference voltage generator further comprises:
a plurality of sample/latch circuits, to receive the encoded data and apply the encoded data received to sample/latch processing for output;
a plurality of digital-to-analog converters, each having a plurality of control signal lines to perform digital to analog conversion according to the encoded data which is outputted by the sample/latch circuit and received by the control signal lines, thereby obtaining the reference voltages; and
a plurality of buffers, to receive the reference voltages, enhance their output amplitudes, and output the reference voltages enhanced to data drivers.

6. The driving circuit as claimed in claim 1, wherein the plurality of characteristic curves are Gamma curves respectively for three primary colors R, G, B.

7. The driving circuit as claimed in claim 1, wherein the driving unit is a data driver.

8. The driving circuit as claimed in claim 1, wherein positive and negative polarities of the characteristic curves respectively have a plurality of selection voltages, each having a range of operating voltage.
